(19) United States
(12) Patent Application Publication
(10) Pub. No.: US 2007/0294262 A1
(43) Pub. Date: Dec. 20, 2007

(54) Communicational identities system

(76) Inventor: Vladimir Boutkovski, Carlsbad, CA (US)

Correspondence Address: Vladimir Boutkovski, 357 Chestnut Ave #19, Carlsbad, CA, 92008, US

(21) Appl. No.: 11/789,343

(22) Filed: Apr. 24, 2007

Related U.S. Application Data
(60) Provisional application No. 60/797,163, filed on May 3, 2006.

(51) Int. Cl. G06F 17/30

(52) U.S. Cl. 707/10; 707/E17.01

(57) ABSTRACT

A system and the method of creation new communications between people and entities seeing in daily life comprising the highly integrated communicational identities system said system working with communicational identities numbers said C-numbers precisely identified with corresponding profiles in sophisticated interactive database said database, assigned and registered to the users, publicly exposable in direct connections with users, implemented through developed system of remote communications between users trough C-numbers based on Internet services, computers and PDA, e-mails and regular mail, phones, cell phones, other communicational devices.

### CROSS-REFERENCE TO RELATED APPLICATIONS

The Application claim the benefit of provisional patent application Ser. No. 60/797,163 filled on May 3, 2006 by the present inventor

### FEDERALLY SPONSORED RESEARCH

Not Applicable

### SEQUENCE LISTING OR PROGRAM

Not Applicable

### BACKGROUND

1. Field of the Invention

The present invention related to a system and to a method of creation interpersonal communications between people and entities by using a publicly exposable, connected to the user's personal communicational identities numbers, registered in specific database and implemented through Internet services, computers, PDA, phones, cell phones and other communicational devices and regular mail.

2. Prior Art

The biggest problems of the modern world of people is the loneliness and fear of rejection in public, which stops us to create desirable level of new contacts and communications with new people.

The social networking services and dating services based on Internet and computers can't solve those problems, because they are not providing us tools to create contacts and communications with people surrounding us in daily lives. They are working in the Cyber World of Internet and dealing only with Cyber images of people and Cyber communications there or as a dating services there are at least starting from them. Most of the people using the modern social networking services on Internet never get any friends for real life and real dates and marriages. A lot of frustrations produce the Internet based dating services where so many people post false info and mastered photos; pretty often the difference between Cyber Image, the personal info on websites database and real persons coming on the first date is so upsetting that it's never produced the following date.

We all spend such a big amount of time behind computers, daily visiting the Cyber world of Internet and gaming through our computers, PDA, cell phones and many of us due to it have no free time for real social life and we start to afraid of the Real world, which is almost completely out of our control compare to the Cyber world. We are afraid see and meet new people, create new contacts, make friend, find new love. The more and more people divorced now, most of our kids prefer to play computer virtual games and pretty often with the cyber partners instead of playing real games with real friends.

Our school, collage students are so lonely and many of them scared by fear of rejections in public are so desperate to find their soul mate and understanding that some of them are even ready to heart all people around.

Both worlds are valuable to us and we need to have both of them in our lives. The cyber world and the real world are beautiful and have a lot to teach us, but these two worlds need to be in the reasonable balance. We need to have the cyber friends and cyber communications on social networking websites as My Space and to see the media, cyber images of the real world through the cyber tubes as You Tube, but we also needed to see the real sky, Sun and stars above us and real people next to us and feel sometimes the worm and lovely hearts beating in time of our real social life instead of watching the 3D adult movies.

“Back to life, back to reality . . . ” from the cyber world to the real people world surrounding us daily, from the cyber friends to the real friends and sole mates, make contacts, friends, create communications with people surrounding us daily, keep your cyber and real worlds in balance this is the goal and abilities of the Communicational Identities System.

### SUMMARY AND OBJECTS OF INVENTION

The Communicational Identities System is the new highly integrated system and method of creation the communications between people and entities seeing each other in daily life, job, vacation, business and any activities in purpose to achieve for them the desirable level of new contacts, social and any communications.

The Communicational Identities System aims to bring the cyber world abilities, based on Internet services, high-tech systems, tools and equipments to the real world of regular people and help them to create new contacts and interpersonal communications with people and entities surrounding them in daily lives and make their lives more interesting, full of new contacts and activities.

The Communicational Identities System as a service is designated to help people create contacts with real people and entities surrounding them in daily life, makes new friends, opens new business possibilities and dating.

This system and services allows people to avoid the fear of rejections in public and bypass it by using C-Numbers System and starting new communication remotely through Internet services, phones, cell phones and any communicational devices and regular mail.

The Communicational Identities System is a new, highly integrated system and Interned bases services, which included the personal communicational identities numbers: C-numbers registered in the system database and exposable to public in different appropriate ways; the sophisticated interactive database of C-numbers and corresponding to them personal profiles of users based on the Internet servers and services, computers, PDA, specific websites and also developed system of communications between users of the system and other people, which included, but not limited by Internet based communications, computers, PDA, phones, cell phones and any proper communication devices, equipments and systems based and provided communications abilities for e-mail and cell phones commutations.
Main Components on Communicational Identities System:
1. Communicational Identities Numbers: C-numbers, which included, but not limited be any chosen for use in the system combinations of letters, numbers, graphical images, marks, signals or codes, which can be precisely identified in database, assigned and registered to the users of the system. By the system requirements, the personal C-numbers recordable on objects to provide their visibility, detectability and can be exposable to the people with direct connections with the System users, their personal items, so they can be identify by their C-Numbers and with connection with them, recognized and contacted by these C-numbers through the permitted way of communications.
2. Communicational Identities Database, which is sophisticated interactive database of C-numbers and corresponding to them personal profiles, allows the users to choose and register the personal C-numbers, create and edit the personal profiles attached to their C-numbers, download media, personal info, permitted way of communications and also to find any personal profile by C-numbers and review the part of these profiles open to the public, disclosed there ways of communication, contact and communications preferences and etc.
3. System of communications between users and users and other people by their C-Numbers, through any allowed ways based but not limited on Internet servers and services, computers and PDA, phones and cell phones, communicational devices, tools and through provided by the System abilities to communicate by registered in the System C-numbers, such as but not limited to e-mails addresses, cell and any phone numbers and regular mails.

C-numbers on Communicational Identities System are anonymous, private, confidential, and secure. The registration doesn't require and doesn't reveal any personal information about users except a name and contact preferences, unless users want to reveal more personal info. Users of System create own profiles in the System and decide what kind of info they'd like to have there.

In time of registration they required to put any name they'd like to use and one contact line: e-mail, pre-paid or regular cell phone and any phone numbers convenient for you, PO Box number or mailing address and chose and register any available C-Number for use.

People by carrying the C-numbers expose themselves to the world with direct connection to their C-Numbers create convenient and friendly communicational ground for secure and safe communications between them and surrounding them people.

The level of communications through System is easy to regulate or stop. Users can close profile, stop exposing to people their C-numbers, change the C-numbers or communicational lines, use pre-paid cell phone as contact lines and change them, use a different PO Box as alternative addresses.

The users of the System can promote their anonymous C-numbers at any dating sites, newspapers and magazines ads and business card.

The Communicational Identities System C-Numbers is a bit similar to the car license plate numbers, it's a new personal, anonymous license plates for communicational traffic, which by being attached to a person or entity, their personal items are exposed to the public in purpose creates for them desirable level of communications.

The Communicational Identity System provides the unique ability immediately send e-mail or cell phone text or any request for communication to a person of interest, which caring C-number from Communicational Identity System or after seeing that person profile info contact the person in any permitted by that person way. The specific websites databases provide to all System users the e-mail accounts or cell phones messages accounts, commutators based on the registered in the System C-Numbers.

If you are seen a person registered in Communicational Identity System who is wearing the C-Number sign and interested in that person, through the System you will obtain right away the person profile permitted info, way to contact and can remotely send immediately request for communications, get responds, sent your photo if needed and in positive case, make a first step to the relationship. No pain and no stress of the first interaction in public.

The most complicated and stressful introductory part successfully bypassed. The well-known fear of rejection in public has been eliminated completely.

The Communicational Identities System is completely private and secure.

No personal info required in time of registration, except the name, contact info and preferences. You can choose any name, nickname, code name, PO Box number; create a new e-mail address or several e-mail addresses, chat number, cell or pre-paid cell phone, mailing addresses and etc.

The Communicational Identities System will be convenient and useful for all people, any social groups and special interests, regardless of age, wealth and gender. The registration in the Communicational Identities System can be canceled at any time and the registration info retrieved. The promotion and exposure of C-Numbers can be stopped at any time by your choice.

Based on the new idea the Communicational Identity System by using Internet, websites, cell and regular phones and all available high tech and regular communicational devices will greatly improve the communicational abilities of people by giving them safe and instant way to create and support the new contacts with new people. Expose yourself to the world and explore the world of communications with people. The loneliness, fear of rejection, luck of love and sex Communication Identities System and people will fight together.

1. A system for creation new communications between people and entities seeing in daily life through highly integrated Communicational Identities System said system, comprising:
a communicational identities numbers said C-numbers, which included, but not limited be any chosen for use in the system combinations of letters, numbers, graphical images, marks, signals or codes, which can precisely identified with corresponding profiles in system database, assigned and registered to the users; visible, detectable C-numbers, exposable to public in different appropriate ways with direct connections with users, their personal items, so users can be identify and by their C-numbers.
a sophisticated interactive database of C-numbers and corresponding to them personal profiles said database, based, but not limited by Internet servers and services and specific websites, computers, PDA, cell phones, which allows the users to choose and register the personal C-numbers, create and edit the personal profiles attached to their C-numbers, download media, personal info, permitted way of communications and also to find any personal profile by C-numbers and review the part of these profiles open to the public, disclosed the ways of communication and preferences.
a developed system of interpersonal, remote communications between users of the system, users and other people by C-Numbers, based but not limited by Internet servers and services, computers and PDA, phones and cell phones, e-mails and regular mail communicational devices, tools and through provided by system Communication on the base of e-mails and cell phone pop3 accounts, commutators.
a integrated e-commerce module providing to users ability to order, create a different kind of exposable C-numbers accessories, apparels and devices and a personal promotional services for users providing in the System and based on C-Numbers classifieds and any proper advertising tools and abilities

2. The widget of claim 1, further including the car's license plate numbers as the personal communicational identities numbers: C-numbers for the users of system who owns, rent, use these cars.

3. The widget of claim 1, further including C-numbers, which are made visible in the night time, performed by glowing material, objects as labels, stickers and any signs, attached to users car, real estate and personal property items, apparels and accessories, rented rooms and cars and any rentable and leased property and items.

4. The widget of claim 1, further including the personal communicational identities numbers: C-Numbers as the base for e-mail accounts in System and the cell phones anonymous addresses in system commutators, which included but not limited by POP3 accounts, cell phone C-Numbers commutators for direct exchange of any kind of messages on the specific websites, devices and equipments.

5. The widget of claim 1, further including the personal communications identification: C-Number exposable to publics in any forms has to contain as the system requirement the registered in specific database C-number itself and precisely identify address of that specific databases, websites, where that C-number and it's corresponding profile can be found.

6. The method of establishing new contacts and communications with people surrounding us in everyday life by using the Communicational Identity System comprising:
creating, selecting from available in System choices the personal identification numbers: C-Numbers, registering them with corresponding profiles in System database, recording C-Numbers to provide their visibility in different ways, exposing C-Numbers to public in direct or obvious connection to users, promoting them through existing ways, finding by C-numbers the personal profiles info of any users, using C-Numbers as the base for interpersonal communications between users and people surrounding them, through Internet services, websites and system communication abilities, by e-mail, mail, cell phones, phones and any communicational devices.

7. The use of Communicational Identities System as local C-Numbers systems created on the cruise line ships, Resorts and SPA; Educational System entities as schools, collages and universities, social and dating services, car drivers and for needs of business meetings, conferences and business, social political feedbacks, polls, a specifically created as the encrypted, coded registration system for the customers of postal services, as the mailing, delivering addresses, Internet, e-mailing, phone, cell phones identifications and any other services and communications by replacing addresses and customers identities with specific groups of private C-Numbers based on special databases, websites and Internet and other system abilities.
